(19) United States
(12) Patent Application Publication
(10) Pub. No.: US 2024/0176635 A1
(43) Pub. Date: May 30, 2024

(54) Virtualized Low-Level Compilation Format Runtimes

(71) Applicant: VMware, Inc., Palo Alto, CA (US)

(72) Inventors: Tiejun CHEN, Beijing (CN); Olivier Alain CREMEL, Los Altos, CA (US)

(21) Appl. No.: 18/059,527

(22) Filed: Nov. 29, 2022

(51) Int. Cl. G06F 9/455; G06F 9/30; G06F 9/54

(52) U.S. Cl. CPC G06F 9/45558; G06F 9/30196; G06F 9/545; G06F 2009/4557; G06F 2009/45583

(57) ABSTRACT

A method for providing a binary format compilation target for an operating system, virtualization platform or kernel includes instantiating one or more modules to create an instance of the binary format compilation target using a an interface compatible with the operating system, virtualization platform or kernel, assigning resources to the instance via the kernel or a kernel of the virtualization platform or operating system, and executing one or more applications on the instance. Source code may be decoded in a virtualization platform to instantiate modules involved in executing applications or processes that are in a native binary format in a virtualized native format instance.

### BACKGROUND

Computer virtualization is a technique that involves using a physical computing machine platform to execute one or more virtual machine(s) (“VM(s)”) executing under control of virtualization software on a hardware computing platform or “host.” A VM provides virtual hardware abstractions for processor, memory, storage, and the like. Virtualization abstracts hardware that allows multiple workloads to share a common set of resources and is a process whereby software is used to create an abstraction layer over computer hardware that allows the hardware elements of a single computer to be distributed among multiple virtual computers. Virtualization software may sometimes be referred to as a “hypervisor.” One example of a hypervisor is the VMware ESXi™ hypervisor provided as part of the VMware vSphere® solution made commercially available from VMware, Inc. of Palo Alto, California.

In various applications, a VM may contain a guest Operating System (“OS”). Multiple Operating Systems (OSs) can run alongside each other, sharing the same physical computing resources. Other types of virtual computing instances (VCIs) may also be used similarly as VMs. In some applications, a hypervisor may be used on a physical server (also known as a bare metal server or a host), without a guest OS. For example, virtualization software can be installed as system level software directly on the server hardware (often referred to as “bare metal” installation) and be conceptually interposed between the physical hardware and the guest operating systems executing in the virtual machines. The hypervisor allows decoupling of the applications from the OS and physical hardware by allowing multiple guest OSs and/or bare metal applications.

While virtualization enables running multiple OSs on the hardware of a single physical server, containerization, on the other hand, enables deploying multiple applications using the same OS on a single VM or server. In particular, containerization is the packaging of software code with just the OS libraries, dependencies, and/or configuration files required to run the code as a single lightweight executable, referred to as a container, which runs consistently on any infrastructure. Containers simplify delivery of distributed applications, and have become increasingly popular as organizations shift to cloud-native development and hybrid multi-cloud environments. Multiple containers can run on a single machine and can share resources. Containers may be run on different OSs or using a hypervisor, such as on different bare metal OSs or different guest OSs operating on a hypervisor.

WebAssembly is a virtual instruction set architecture for running bytecode within web browsers or on a host. WebAssembly is a binary-code format compilation target. It may be used to enable various web-based client and server applications, interactions using low-level runtime environments, and in other applications and interactions.

WebAssembly's portability, small size, fast loading, and compatibility provide great potential. So, it would be desirable to execute processes in WebAssembly (or any other low level format), using a virtualized environment to carry out workloads. It would be desirable to further include benefits of hardware assisted virtualized technology. However, traditional implementations of WebAssembly when deployed often duplicate large overhead and bootstrapping costs, introduce security or reliability risks, and do not fit well into the virtualization environment.

It should be noted that the information included in the Background section herein is simply meant to provide a reference for the discussion of certain embodiments in the Detailed Description. None of the information included in this Background should be considered as an admission of prior art.

### BRIEF DESCRIPTION OF THE DRAWINGS

FIG. 1A illustrates a schematic diagram for virtual machine based virtualization technologies, according to various embodiments.

FIG. 1B illustrates a schematic diagram for container based virtualization technologies, according to various embodiments.

FIG. 1C illustrates a schematic diagram for container-in-VM based virtualization technologies, according to various embodiments.

FIG. 1D illustrates a schematic diagram for unikernel based virtualization technologies, according to various embodiments.

FIG. 2 illustrates a diagram of an intermediate representation for programming languages, according to various embodiments.

FIG. 3 illustrates a schematic diagram of a WebAssembly runtime instantiation, according to various embodiments.

FIG. 4 illustrates a schematic diagram of a WebAssembly runtime system, according to various embodiments.

FIG. 5 illustrates is a schematic diagram of a WebAssembly runtime in a standard cloud environment, according to various embodiments.

FIG. 6 illustrates a schematic diagram of a WebAssembly runtime system, according to various embodiments.

FIG. 7 illustrates a schematic diagram of a WebAssembly runtime system, according to various embodiments.

FIG. 8 illustrates is a schematic diagram of a WebAssembly runtime, according to various embodiments.

FIG. 9 illustrates a modified WebAssembly runtime system, according to various embodiments.

FIG. 10 is a schematic diagram of compilation of an application in a virtualized binary format runtime environment, according to various embodiments.

FIG. 11 is a flow chart illustrating a sample workflow using a virtualized binary instruction format runtime, according to various embodiments.

### SUMMARY OF THE INVENTION

The present disclosure relates to virtualized low-level compilation format runtimes. In various embodiments, the virtualized low-level compilation format runtimes are for executing certain applications or low-level processes natively in a virtualized environment. Disclosed herein are methods, computer-readable medium, and related systems, for executing one or more processes in binary format in virtualized runtime instances. In various embodiments, a decodable binary source file is received at an interface. The source file may be decoded by the interface to generate a decoded file. One or more modules required by the source file may be instantiated in a virtualized runtime instance. Resources required by the one or more modules may be assigned to the virtualized runtime instance. The decoded file may be executed in the virtualized runtime instance.

### DETAILED DESCRIPTION

Embodiments of the present disclosure provide a lightweight and secure runtime environment for WebAssembly that runs alongside virtual computing instances (VCIs) such as virtual machines (VMs) and containers in a virtualized computing environment. WebAssembly includes a binary format core standard library and defines an instruction set architecture consisting of specific binary encodings of types of operations which may be potentially executed by a VCI. The list of instructions includes standard memory load/store instructions, numeric, parametric, control of flow instruction types and WebAssembly-specific variable instructions. By providing a WebAssembly runtime environment within a virtualized computing environment, such as running on top of a hypervisor, techniques described herein allow lightweight WebAssembly applications and/or processes to be executed in a virtual runtime environment using a WebAssembly interface to interact with an underlying system, thereby taking advantage of the benefits of virtualization in conjunction with the benefits of WebAssembly.

In some applications, the underlying system may be an Operating System (OS). In other applications, the system may use a hypervisor to directly run instances. A hypervisor may include a kernel used to run instances of the modules required for the WebAssembly runtime and may include a collection of operating system components performing some or all operating system functions for a computing system.

In other applications, a virtual machine kernel is used to run instances of the modules required for the WebAssembly runtime. A virtual machine kernel is a collection of operating system components performing some or all operating system functions for a computing system.

A hypervisor kernel or virtual machine kernel may include a memory manager, process scheduler, input/output, device drivers, security management, page tabling, resource management, or other system components. Such kernels allow a host machine to run multiple isolated virtual environments. Various operating systems may include a hypervisor kernel, a virtual machine kernel, or like components, which may be implemented to create multiple virtual machines.

Thus, aspects of the present invention apply to hypervisor kernels or other virtual machine kernels having components performing some or all operating system functions. However, it will be understood while that aspects, such features may be applicable as well as to other components or to other collections of components performing operating system functions.

In some situations, using a virtual machine kernel or hypervisor kernel results in a runtime with better performance or lower bootstrap cost or footprint, since only modules needed for the WebAssembly process must be instantiated in the virtual runtime instance. The runtime instance includes the modules and libraries needed to interface with the underlying kernel and execute the WebAssembly process. The WebAssembly interface is able to interface with an underlying OS or Hypervisor kernel.

By abstracting the modules, libraries, and dependencies and instantiating them in a virtualized runtime instance (e.g., which may comprise a software component that runs on an OS or hypervisor), WebAssembly may be run in a virtualized environment in a number of ways and, in some cases, from cloud to edge. Various configurations may take advantage of operating services provided by an underlying system, or may be tailored for a “bare metal” implementation. Various implementations include an interface between WebAssembly and a virtual machine kernel or hypervisor kernel running a WebAssembly runtime instance.

In various applications, the interface between the WebAssembly runtime instance and the underlying system may isolate the application or process from other applications and from the underlying system to improve security and reliability.

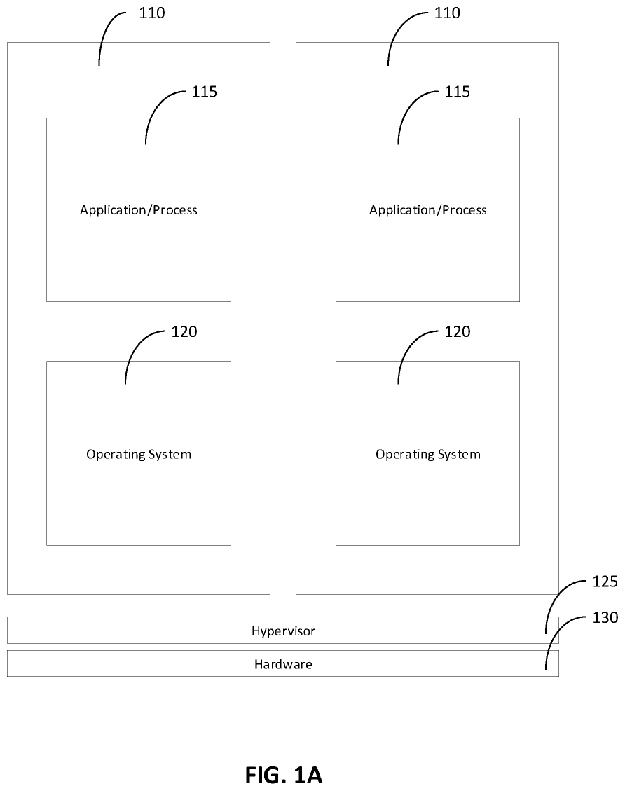

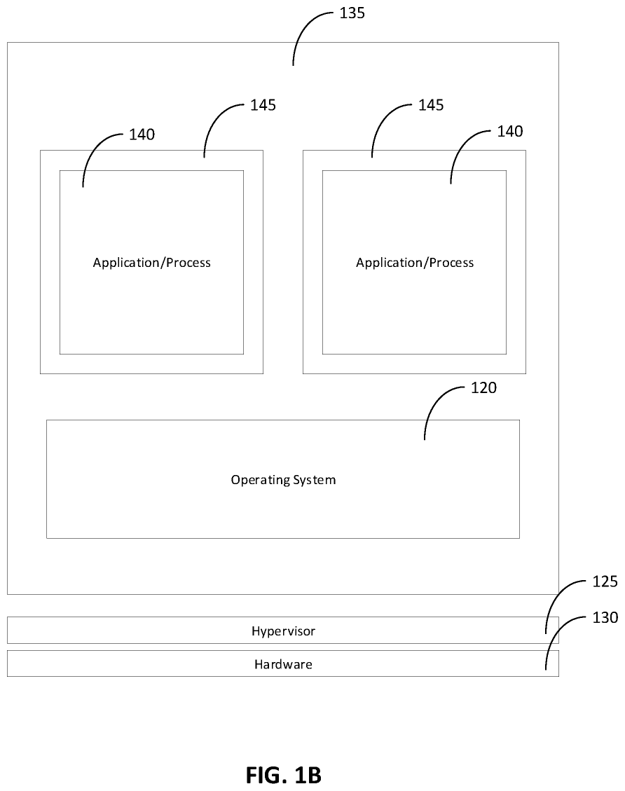

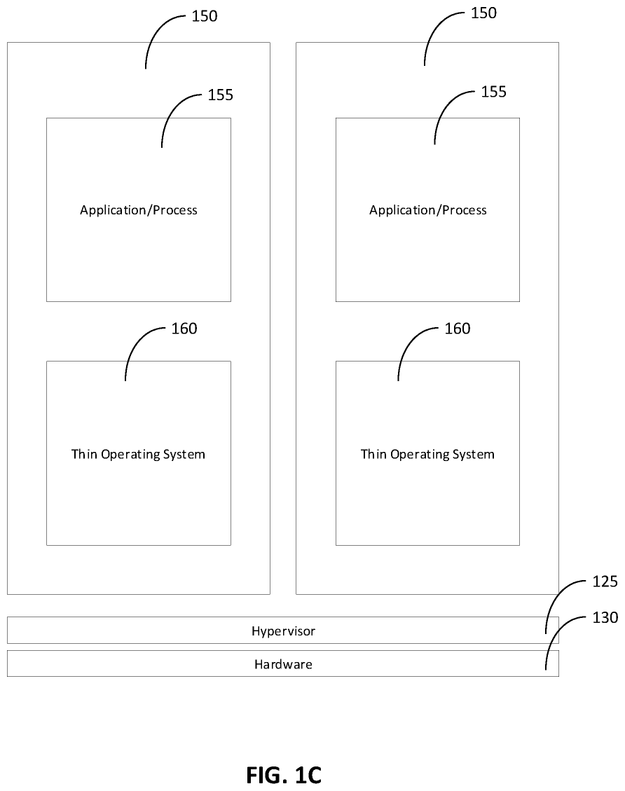

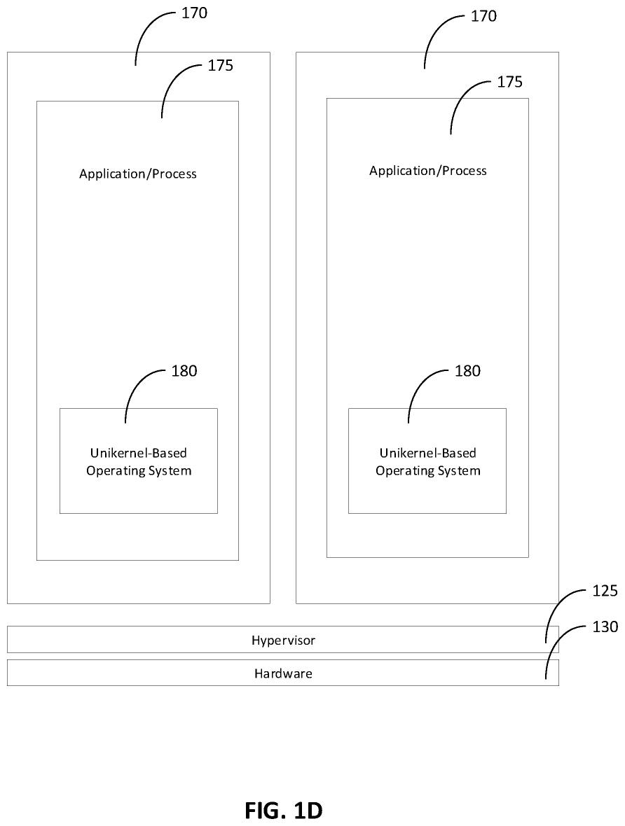

FIGS. 1A-D illustrate schematic diagrams for various virtualization technologies with which embodiments of the present disclosure may be implemented. The diagrams provide examples abstractions of the application layer using virtualization and/or containerization. For example, a WebAssembly runtime environment as described herein may run in any of the virtualized computing environments depicted in FIGS. 1A-D.

FIG. 1A illustrates a schematic diagram for virtual machine based virtualization technologies. It is noted that portions of the present disclosure referring to VMs may also apply to other types of VCIs such as containers. In FIG. 1A, one or more virtual machines 110 include one or more applications 115 and one or more guest operating systems 120 (e.g., each of which may be referred to as a guest OS, as it runs as a guest within a VM). A hypervisor 125 manages operation of the underlying hardware resources 130 and abstracts those hardware resources 130 for use by virtual machines 110. In the example of FIG. 1A, the one or more applications 115 are run on top of the guest operating systems 120 of the virtual machines 110. Each virtual machine 110 includes a guest operating system 120 and configuration files, libraries, and dependencies required for different applications to run. The virtual machines 110 are managed by a hypervisor 125 that partitions and distributes computing resources and physical hardware resources 130 to the virtual machines 110.

FIG. 1B illustrates a schematic diagram for container based virtualization technologies. In FIG. 1B, one or more virtual machines 135 each include one or more applications 140 and a guest operating system 120. The applications 140 are containerized in respective containers 145. The containers 145 can include configuration files, libraries, and dependencies required for the respective containerized application 140 to run. An optional hypervisor 125 manages operation of the underlying hardware resources 130. In the example of FIG. 1B, the one or more applications 115 are run in the guest operating system 120 of the virtual machines 110.

FIG. 1C illustrates a schematic diagram for container-in-VM based virtualization technologies. In FIG. 1C, one or more virtual machines 150 include respective applications 155 and thin operating systems 160. The applications 155 may be run in the respective thin operating systems 160 of the virtual machines 150. A thin operating system 160 may differ from a guest operating system in that a thin operating system 160 may contain operating components specific to a respective application 155 and may leave out other operating components. A hypervisor 125 manages operation of the underlying hardware resources 130. In the example of FIG. 1C, the one or more applications 155 are run in the thin operating systems 160 of the virtual machines 150.

FIG. 1D illustrates a schematic diagram for unikernel based virtualization technologies, such as libOS or like unikernel technologies. In FIG. 1D, one or more virtual machines 170 include respective applications 175 packaged with respective unikernel-based operating system 180. Using unikernel based virtualization, code for the applications 175 is bundled together with the minimum necessary OS functionality to run the application 175. Thus, the applications 175 may be run without requiring a traditional guest operating system. In some embodiments, the applications 175 may be narrow in purpose and not require a full operating system. Rather, a unikernel 180, or unikernel based operating system is hosted in the respective virtual machines 170. A hypervisor 125 manages operation of the underlying hardware resources 130. The applications 175 may be run in the respective unikernels 180 of the virtual machines 170.

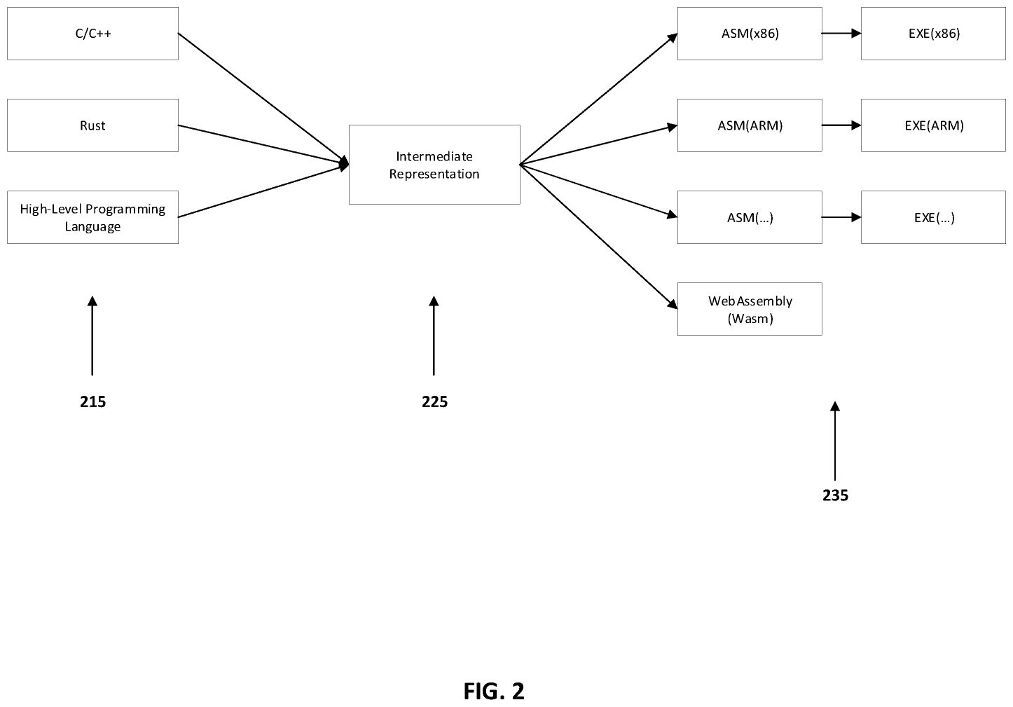

FIG. 2 illustrates a diagram of an intermediate representation for programming languages. In the example shown, high level programming languages 215 may be compiled into an intermediate representation 225 before being compiled further into an assembly language 235. For example high level programming languages 215 such as C/C++ or Rust, may have an intermediate representation 225 as a data structure. The intermediate representation 225 can be used internally by a compiler or by a VCI such as a virtual machine to represent the source code. This intermediate representation can be complied into, for example, various object code, machine code, or WebAssembly formats.

As will be discussed in further detail, a source file of a higher-level format may be decoded into an intermediate format by an interface between the source file and a virtualization environment, such as one of the virtualized computing environments described above with respect to FIGS. 1A-D. The decoded source file may contain information about modules and resources necessary to execute an application of the source file. The module may be instantiated with the resources to enable execution of the application, such as by an operating system, hypervisor, hypervisor kernel, or virtual machine kernel.

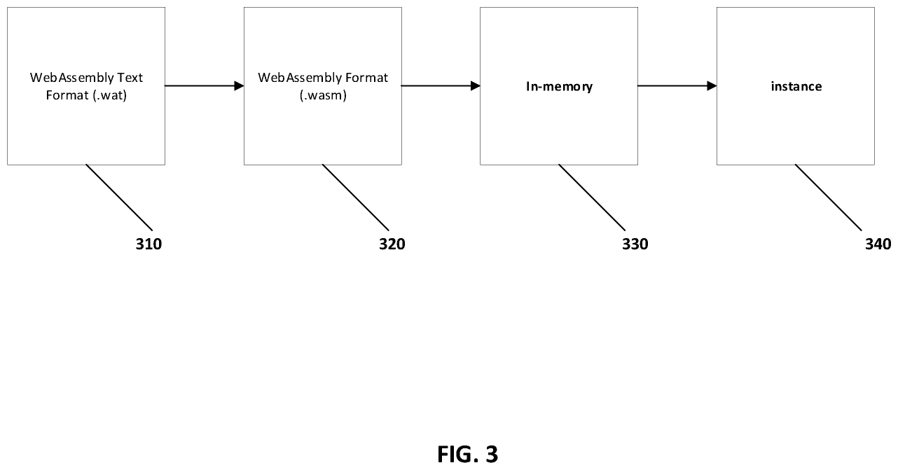

FIG. 3 illustrates a schematic diagram of a WebAssembly instance being instantiated. In FIG. 3, a source file 310 is compiled into a WebAssembly format file 320. For example, C/C++, Rust, or other programming languages may be compiled into WebAssembly format, or into an intermediate format compilable by WebAssembly or decodable by a WebAssembly interface. Alternatively, a source file that is in binary or WebAssembly format can be used. The WebAssembly code file 320 is decoded in a memory location 330 and validated (e.g. confirmed to be compatible with runtime modules and/or constraints). Modules necessary for the decoded application are instantiated into a WebAssembly virtual machine runtime instance 340, which executes the decoded application.

As discussed further below, the instance 340 includes an interface with the underlying system providing access to I/O operations, memory, CPU, and/or any other devices or resources needed for execution of WebAssembly applications. In various embodiments, the instance 340 may be lightweight and contain only the modules needed for the WebAssembly code to execute. After the instance is instantiated, the Web Assembly code may be executed.

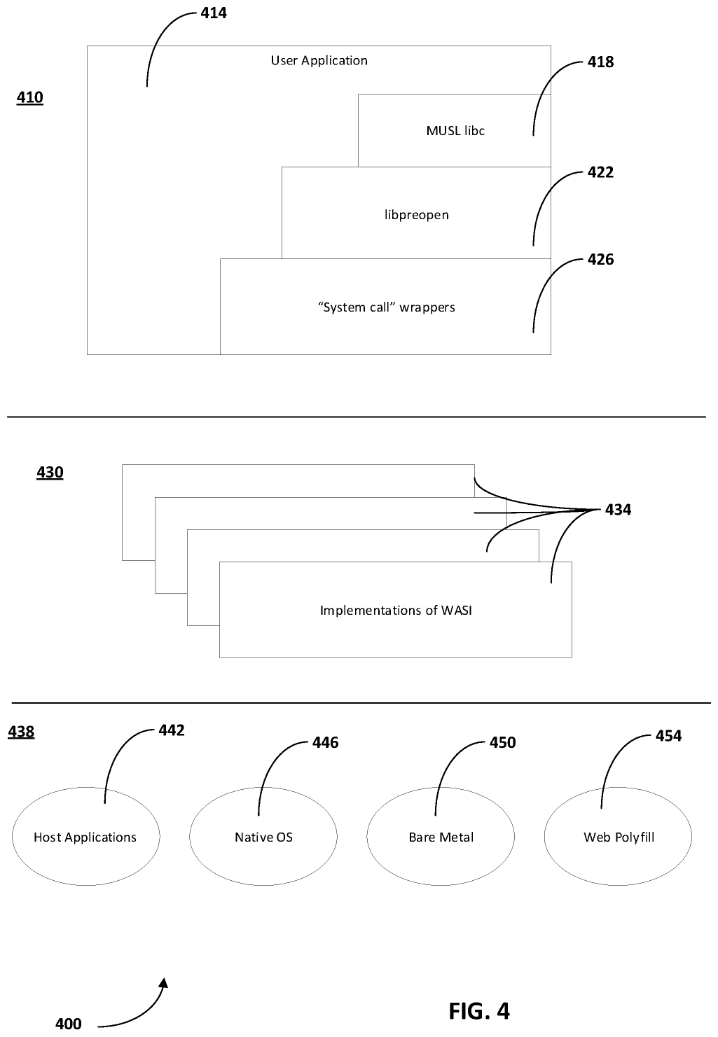

FIG. 4 illustrates a schematic diagram of a sample WebAssembly runtime system interface 400. In FIG. 4, a first layer 410 of the interface 400 is a user-space layer that includes a user application layer 410 including a user application 414, one or more library layers 418, 422, and one or more system call wrappers 426. The library layers 418, 422 may include a standard library 418 of a programming language, such as a standard C library for C, or other library contents providing high level functionality. A second preopen library 422 includes low level C/C++ interfaces for system code. A “System call” wrapper layer 426 may enable the application 414 and libraries 414, 418 to make calls to a WebAssembly interface layer 430.

The WebAssembly interface layer includes one or more implementations of a WebAssembly interface 434. The WebAssembly interfaces 434 enable the user application to interface with an underlying system layer 438. The system layer 438 is a “Ring 0” in a “kernel space” separate from the “Ring 3” user space. The system layer 438 can include a Host application 442, a native or guest operating system 446, a “Bare Metal” kernel 450, and/or a web polyfill 545. In web development, a polyfill is code that implements a feature on web browsers that do not natively support the feature. In various uses, the most suitable underlying system may be selected.

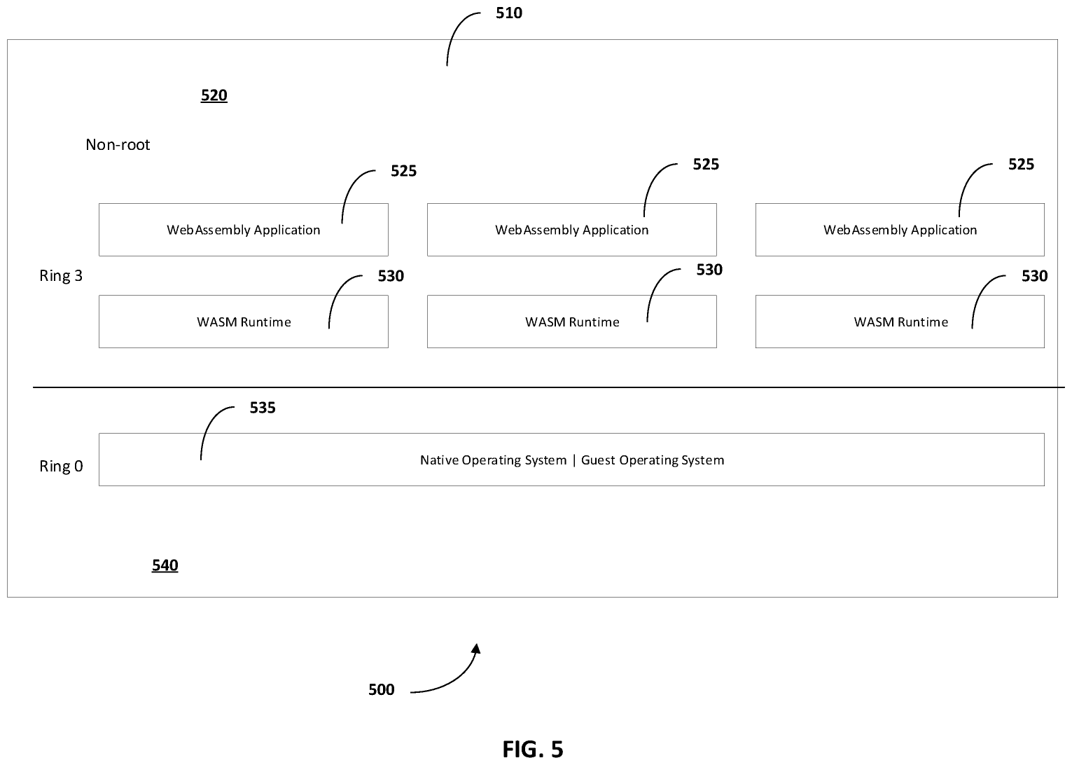

FIG. 5 illustrates a schematic diagram of a WebAssembly runtime 500. FIG. 5 represents a runtime 500 deployed in a standard cloud environment 510. As shown, a non-root mode, “Ring 3” layer 520 includes a plurality of WebAssembly applications 525 with respective WebAssembly runtime instances 530, in a native or guest operating system 535 of the environment 510, which may represent a typical cloud environment. The operating system 535 operates in a “Ring 0” system space layer 540. The operating system 535 manages and assigns system resources, and the WebAssembly applications 525 do not have root access to the underlying cloud environment 510.

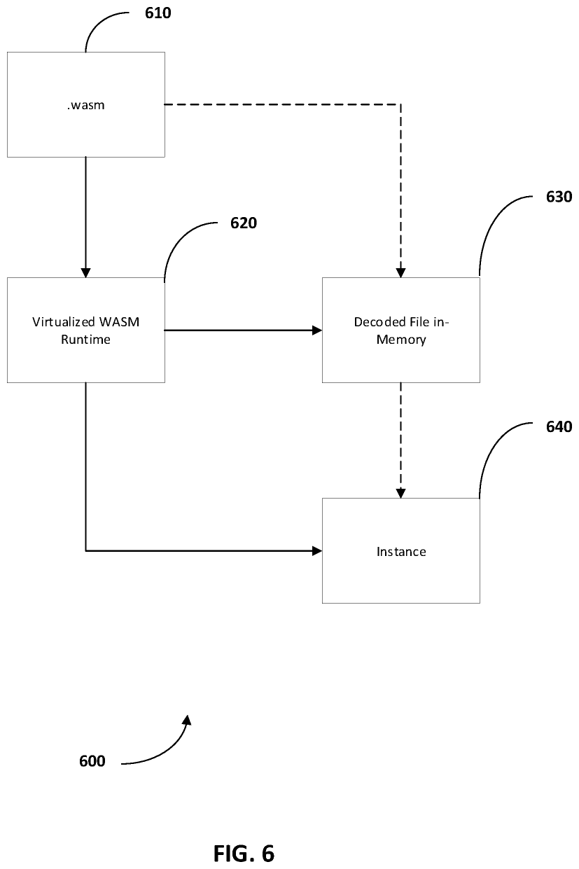

FIG. 6 illustrates a schematic diagram of a WebAssembly runtime 600. As shown, a source WebAssembly file 610 is loaded in a virtualized WebAssembly Runtime 620. For example, the source file 610 may be a binary file, or a file compilable into a WebAssembly file. The source file 610 is decoded to a decoded file 630 in-memory.

Modules associated with the WebAssembly source file 610 are instantiated in a runtime instance 640. In the example shown, a virtualization environment (for example, as described above with respect to FIGS. 1A-D) may manage and assign resources to the runtime instance. In various embodiments, any number of instances may be instantiated and managed by the virtualization environment (e.g., which may be implemented via a hypervisor). Note that this virtualized WebAssembly runtime 620 and WebAssembly applications 640 may be in “Ring 3—Root mode” along with other applications in the hypervisor.

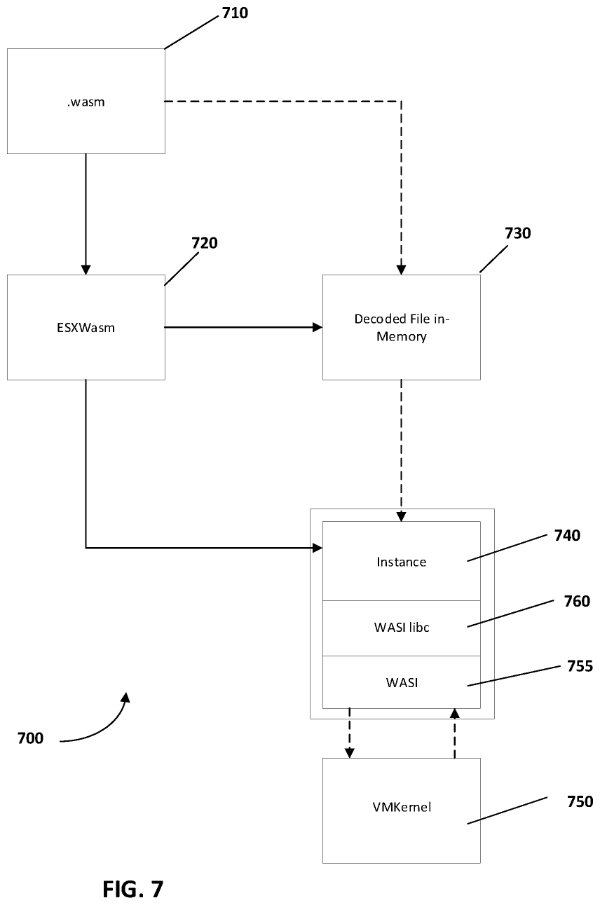

FIG. 7 illustrates a WebAssembly runtime 700 similar to that of FIG. 6. As shown, the runtime 700 includes a runtime instance 740 running using a hypervisor kernel 750. The instance 740 is logically isolated in a “Ring 3” user-space but in “Root mode”. The instance 740 includes the WebAssembly interface 755 and one or more WebAssembly interface libraries 760. In the example shown, the WebAssembly interface 755 and libraries 760 associated with the application are included on the runtime instance 740. The runtime instance 740 may be run using the hypervisor kernel 750 to provide any needed resource management (virtual CPU, virtual memory, etc.), I/O operations, page tabling etc. needed for execution of a source file 710.

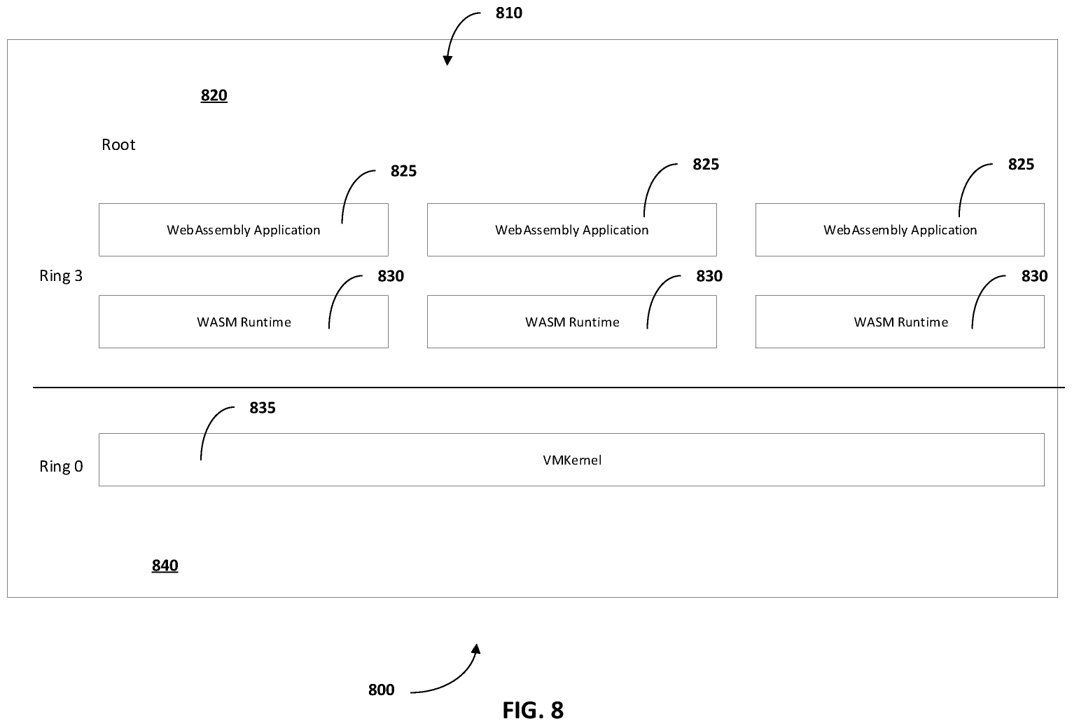

FIG. 8 illustrates is a schematic diagram of a WebAssembly runtime. FIG. 8 represents a runtime 800 deployed in an environment 810 using a hypervisor kernel 850. As shown, a root mode, user application layer 820 includes a plurality of WebAssembly applications 825 with respective WebAssembly runtime instances 830, in a virtual machine kernel 850 of the environment 810. The hypervisor kernel 850 manages and assigns system resources, the WebAssembly applications 825 in this example have root access to the underlying hypervisor kernel 850. The applications 825 are able to access system resources and I/O operations using the hypervisor kernel 850.

In contrast to the runtime shown in FIG. 5, the WebAssembly applications 825 in the “Ring 3” layer are in a root mode, not a non-root mode. The applications are run using a hypervisor kernel instance to which the necessary computing resources can be assigned and in which the necessary WebAssembly modules may be instantiated to execute the respective applications (or processes). This solution may suitable for WebAssembly applications related to system calls or services. However, this may grant too much access to some types of user applications running in the instances 830, and may likewise pose risks related to security and reliability. Thus, there is a further need to isolate instances 830 from the underlying system while still allowing the user applications to run in the lightweight virtualized WebAssembly runtime environment using a hypervisor kernel.

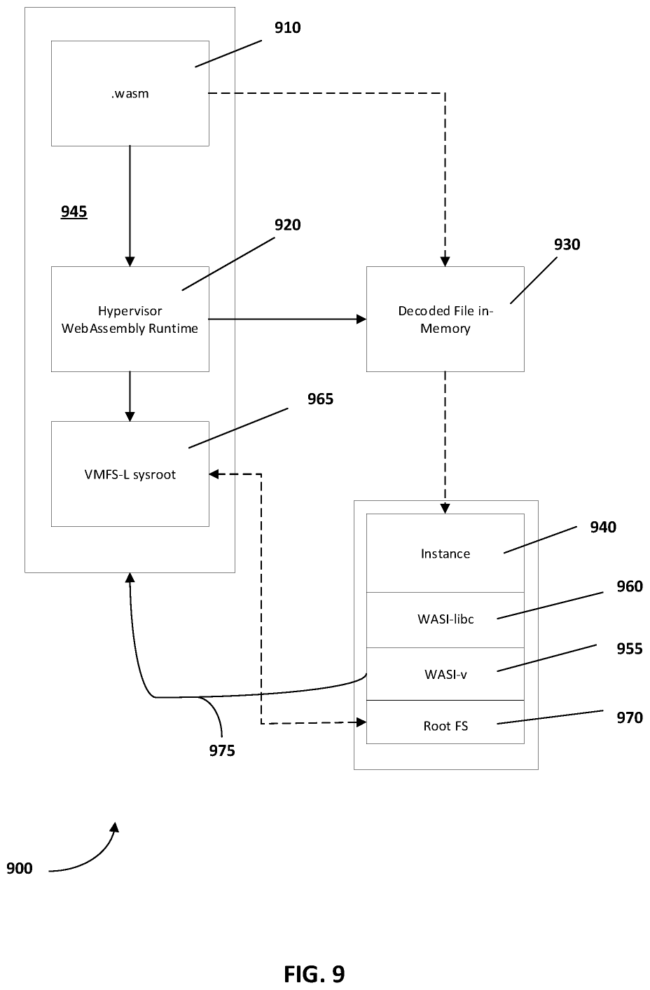

FIG. 9 illustrates a modified WebAssembly runtime 900. A source file 910 (such as a WebAssembly file or .wasm binary file) can be loaded using a WebAssembly runtime 920. In the example shown, a hypervisor is used to virtualize the WebAssembly runtime 920. The source file 910 is loaded via this hypervisor WebAssembly runtime 920. The hypervisor WebAssembly runtime 920 decodes the source file 910 into a decoded file 930 in memory. The necessary WebAssembly modules for a runtime application associated with the source file are instantiated in an instance 940.

In the example of FIG. 9, the instance 940 includes a WebAssembly interface 955 and libraries 960 associated with the application. A virtual machine disk 965 may also be mounted to the instance 940 (for example a VMFS-L virtual disk or other partition) as a root 970 of the file system of the instance 940. A virtualization environment 945 (for example, comprising a hypervisor as described above with respect to FIGS. 1A-D) manages and assigns resources to the virtual machine instance 940, such as by assigning CPU and memory, and/or providing a mapping table, and includes necessary modules. However, the lightweight nature of the WebAssembly runtime instance is preserved, as unnecessary module and/or operating instructions may be omitted when new instances are instantiated for a WebAssembly application or process.

In the example of FIG. 9, WebAssembly applications are able to run inside the virtual machine instance but are more isolated from the underlying system and from other application than the implementations of previous examples. Rather than a hypercall for passing information or commands between the virtualization environment and the underlying kernel, a system call 975 (or “syscall”) to the WebAssembly interface 955 is used.

In some embodiments, instance 940 may be run using a virtual machine kernel underlying the WebAssembly runtime instance that does not include a full operating system [e.g. an OS fully compatible with the Portable Operating System Interface (“POSIX”)]. Therefore, to provide the WebAssembly application access to I/O, CPU and memory, and other resources, a system call is used.

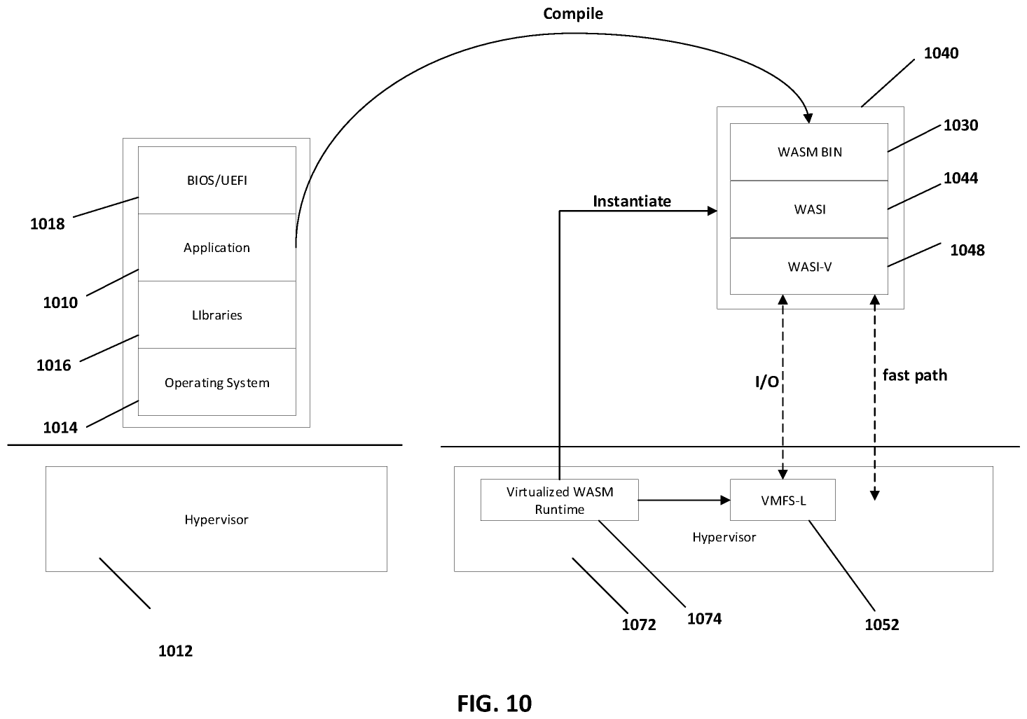

FIG. 10 is a schematic diagram of compilation of an application in a virtualized binary format runtime environment. In the example of FIG. 10, an application 1010 is compiled to a WebAssembly binary format inside a virtualized computing environment. The application 1010 may be initially hosted in a stack consisting of a hypervisor 1012, an operating system 1014, one or more libraries 1016, or a BIOS/UEFI layer 1018. The application 1010 may be compiled to a WebAssembly binary format file 1030. The WebAssembly binary format file 1030 may be instantiated in a virtual runtime instance 1040. A WebAssembly interface 1044 and one or more WebAssembly interface libraries 1048 are instantiated on the virtual runtime instance 1040. A virtual disk 1052 (for example a VMFS-L format virtual disk) is mounted as a root of a file system for the virtual runtime instance 1040.

In various embodiments, low level libraries may be associated with a fast path 1060 between the runtime instance and an underlying system 1070. In the example of FIG. 10, the underlying system includes a hypervisor 1072, and a virtualized WebAssembly runtime 1074 between the hypervisor and the virtual runtime instance 1040. In the example shown, the virtual runtime instance is a WebAssembly runtime instance. In various embodiments, the virtualized WebAssembly runtime 1074 may decode a source file to generate a decoded file. Modules to execute the source file may be determined from the decoded file. The modules may be selected from low level and high level libraries. Computing resources to execute the source file may be determined from the decoded file. In various applications, the resources may be assigned by system calls to an underlying kernel or to hypercall to an underlying hypervisor.

In the example shown, the WebAssembly interface 1044 may initiate I/O (and take advantage of fast pathing, such as DirectI/O, for VMFS-L or other virtual drive types), request computing resources, perform page tabling, or otherwise interact with the underlying environment 1070. In embodiments where security is necessary, the instance 1040 may be logically isolated from the underlying system 1070, as well as from other instances by maintaining the virtual runtime instance 1040 in a “Ring 3” user space. When a hypervisor or OS is used, such as in the example of FIG. 10, the instance may use an interface to take advantage of operating services provided by the underlying operating system or hypervisor.

In various embodiments, a virtualized binary format runtime instance may be in a root mode or non-root mode. In the example of FIG. 10, the instance is in a ring-3, non-root mode. A root mode may be useful where a hypervisor or guest operating system is present. However, for “bare metal” processes, allowing the processes to run in root mode may pose risks related to security and/or reliability. Allowing the processes to do so may be desirable in some cases. For example, such a set-up may preferable for system calls, system services, or bitwise operations in some cases.

In other embodiments, the WebAssembly interface 1044 may run in a non-root mode without a guest operating system or hypervisor. Rather, a kernel of a virtualization environment may be used. An instance of the kernel may include an interface for interacting with a runtime on the kernel. The runtime on the kernel may provide operating services for the application via the interface. In this way, separation is maintained via the interface. This setup may have a reduced boot time for Basic Input Output System (BIOS) or for Unified Extensible Firmware Interface (UEFI) firmware, reduced bootstrapping cost, and/or may eliminate overhead associated with an operating system or hypervisor.

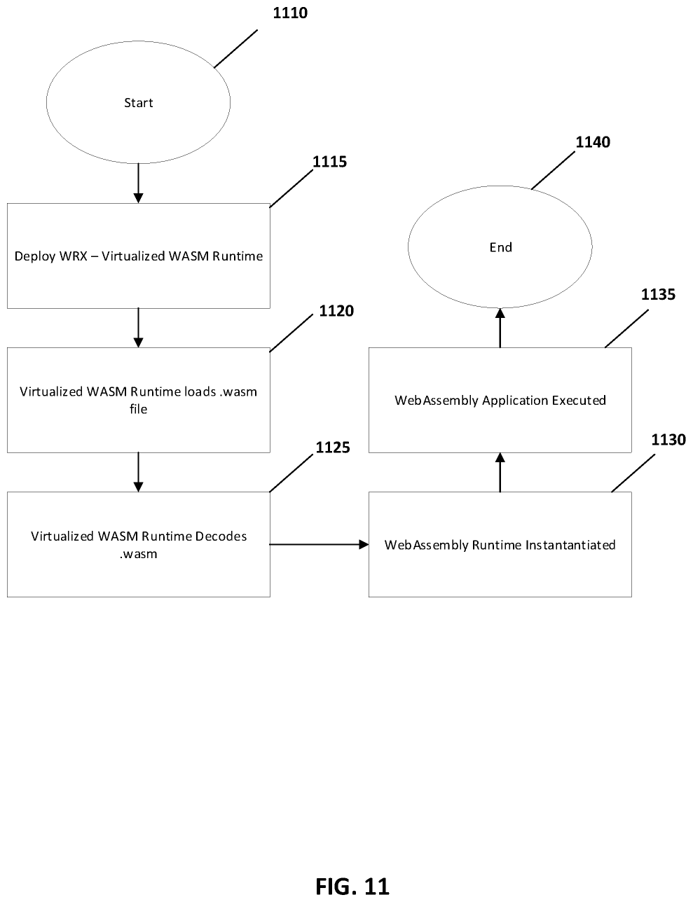

FIG. 11 is a flow chart illustrating a sample workflow 1100 using a virtualized binary instruction format runtime, according to various embodiments. As shown, the workflow 1100 begins at start block 1110 and proceeds to stage 1115 where the WebAssembly runtime is deployed in the virtualization environment (e.g., as described above with respect to FIGS. 1A-D). For example, a virtualized WebAssembly runtime may be deployed in a hypervisor.

From stage 1115 where the runtime is deployed, the workflow 1100 may proceed to stage 1120 where the virtualized WebAssembly interface loads a WebAssembly file. For example, the file may be binary format, or may be a compiled or intermediate representation of a higher level programing language such as, for example, C/C++ or Rust.

From stage 1120 where the WebAssembly file is loaded into the virtualized Web Assembly interface, the workflow may proceed to stage 1125 where the WebAssembly file is decoded in memory to an in-memory format (a format in which the data is stored in memory).

From stage 1125 where the WebAssembly file is decoded in memory, the workflow may proceed to stage 1130 where a virtualized WebAssembly Runtime instance is instantiated. According to various embodiments, instantiating the Runtime instance includes loading all necessary modules, libraries, and dependencies and instantiating them as runtime instances in memory. In various embodiments, instantiating the Runtime instance includes setting parameters for the virtual machine, including assigning vCPU and other computing resources and generating or extending page tables mapping virtual and physical addresses for data. In various embodiments, a virtual machine disk is mounted as a root of a file system of the Runtime instance. In the example shown, a VMFS-L format disk is mounted, although it will be appreciated that other formats may be suitable in various applications. Once instantiating of all necessary components is complete, the WebAssembly file may be executed. The WebAssembly file may contain instructions for performing various services, processes or applications.

From stage 1130 where the virtualized WebAssembly Runtime instance is instantiated, the workflow 1100 may proceed to stage 1140 where the WebAssembly file is executed. While a WebAssembly application or process is running, the low level WebAssembly interface library may be used to access the root file system (for example, a mounted VMFS-L disk). In the example workflow 1100, to engage with the underlying kernel while running, a system call to the low-level WebAssembly interface library may be used. A guest OS is not necessary in such an application, allowing the instance to be more lightweight with a lower bootstrapping cost.

The various embodiments described herein may employ a binary-format compilation target, such as WebAssembly. However, it will be appreciated that aspects of the present invention relate in various embodiments to, by way of non-limiting example, binary-format, assembly language, machine code, object code, and/or intermediate representations. Aspects of the present invention also relate, by way of non-limiting example, to high level programming languages, as well as their compiled forms or any intermediate representations. Furthermore, aspects of the present invention may relate to compilation targets such as x86 or ARM, and likewise to instruction sets including a WebAssembly instruction set, a Complex Instruction Set, a Reduced Instruction Set, or other instruction set.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

In addition, while described virtualization methods have generally assumed that virtual machines present interfaces consistent with a particular hardware system, the methods described may be used in conjunction with virtualizations that do not correspond directly to any particular hardware system. Virtualization systems in accordance with the various embodiments, implemented as hosted embodiments, non-hosted embodiments, or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest Operating System that performs virtualization functions. Plural instances may be provided for components, operations or structures described herein as a single instance. Finally, boundaries between various components, operations and datastores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

We claim:

1. A method for executing one or more binary-format processes in one or more virtualized runtime instances, comprising;
receiving, at an interface, a source file decodable into a binary format;
decoding, by the interface, the source file to generate a decoded file;
instantiating, in a virtualized runtime instance, one or more modules involved in executing a process of the source file;
assigning resources involved in executing the process to the virtualized runtime instance; and
executing the process in the virtualized runtime instance.

2. The method of claim 1, wherein the interface stores the decoded file in memory and the method further comprising determining the one or more modules involved in executing the source file based on the decoded file.

3. The method of claim 1, further comprising mounting a virtual machine disk as a root file system of the virtualized runtime instance.

4. The method of claim 1, wherein executing the decoded file in the virtualized runtime instance comprises making a system call to a kernel of the virtualized runtime instance.

5. The method of claim 4, wherein the one or more modules involved in executing the source file include operating instructions not included in the kernel.

6. The method of claim 1, wherein instantiating the one or more modules includes loading one or more application libraries onto the virtualized runtime instance.

7. The method of claim 1, wherein instantiating the one or more modules includes loading one or more system libraries onto the virtualized runtime instance.

8. The method of claim 1, wherein the virtualized runtime instance is associated with a hypervisor, and the executing the decoded file comprises making a hypercall to the hypervisor.

9. The method of claim 1, wherein assigning resources involved in executing the source file includes assigning partitions of virtual processing resources and virtual memory resources.

10. The method of claim 1, wherein the virtualized runtime instance is an instance of a virtualized WebAssembly runtime that runs on top of a hypervisor.

11. The method of claim 1, wherein the decoded file is executed in a binary format in the virtualized runtime instance.

12. The method of claim 1, wherein the virtualized runtime instance is in a root mode of a virtualization environment.

13. The method of claim 1, wherein the virtualized runtime instance is in a non-root mode of a virtualization environment.

14. A non-transitory computer-readable medium comprising instructions that, when executed by one or more processors of a computing system, cause the computing system to perform operations for executing one or more binary-format processes in one or more virtualized runtime instances, comprising:
receiving, at an interface, a source file decodable into a binary format;
decoding, by the interface, the source file to generate a decoded file;
instantiating, one or more modules involved in executing the source file in a virtualized runtime instance;
assigning resources involved in executing the source file to the virtualized runtime instance; and
executing the decoded file in the virtualized runtime instance.

15. A system comprising:
one or more processors; and
at least one memory, the one or more processors and the at least one memory configured to cause the system to:
receive, at an interface, a source file decodable into a binary format;
decode, by the interface, the source file to generate a decoded file;
instantiate one or more modules involved in executing the source file in a virtualized runtime instance;
assign resources involved in executing the source file to the virtualized runtime instance; and
execute the decoded file in the virtualized runtime instance.
